(19) United States
(12) Patent Application Publication
(10) Pub. No.: US 2004/0233389 A1
(43) Pub. Date: Nov. 25, 2004

(54) Balance system with roll handle for hand-held cameras

(76) Inventor: Christoph F Bruggaier, Oberhaching (DE)

Correspondence Address: DILWORTH & BARRESE, LLP, 333 EARLE OVINGTON BLVD., UNIONDALE, NY, 11553, US

(21) Appl. No.: 10/484,661

(22) PCT Filed: Jul. 26, 2002
(86) PCT No.: PCT/EP02/08395

(30) Foreign Application Priority Data
Jul. 26, 2001 (DE) 101 36 341.9

(51) Int. Cl. G03B 17/00

(52) U.S. Cl. 352/243; 396/420

(57) ABSTRACT

A balance system (1), for hand-held cameras (9), comprises a balance arm (2) and a handle (3). The balance arm (2) may be connected to a camera retaining mechanism (10) and may be swivelled, relative to the handle (3), about a swivelling axis (S) and tilted about a tilting axis (N), running essentially perpendicular to the swivelling axis (S). The balance arm (2) may furthermore be rotated about a roll axis (R) relative to the handle (3), which also runs essentially perpendicular to the swivelling axis (S) in the case of a non-tilted camera (9). The balance arm (2) may thus be rotated in an unrestricted manner about the roll axis (R) relative to the handle (3).

### TECHNICAL FIELD

The present invention concerns a balance system for hand-held cameras according to the preamble of claim 1.

Such balance systems are used to balance hand-held video and film cameras, where a handle is provided to guide the camera with one hand. The balance system is intended to prevent the tilt and tipping movements of the handle being transferred to the camera, since a constant camera alignment must always be guaranteed and tipping or tilting of the camera avoided. For this the balance system is designed so that the camera can perform a swinging movement in relation to the handle. To balance the camera counterweights are used which are attached to one end of a balance arm which at its other end is attached to the camera structure. With suitable selection and positioning of the balance weights, the arrangement of the balance arm and counterweights balances the camera so that tilting and tipping movements are not transferred from the handle to the camera.

### PRIOR ART

In the prior art such balance systems are known for guiding conventional film and video cameras. For example U.S. Pat. No. 4,946,272 describes such a balance system in which the balance arm is curved. At its one end the balance arm is connected with a camera retaining mechanism on which can be attached a film or video camera or other equipment to be balanced, and at the other end of the balance arm can be attached the counterweights. The entire assembly of camera, camera retaining mechanism, curved balance arm and counterweight is connected with a handle via a ball joint so that the handle can be tilted and tipped without the camera following these movements.

A handle to guide a camera should not only decouple the camera as completely as possible from the movements of the cameraman's hand and hence the handle which should not be transmitted to the camera. It must also be possible to swivel the camera about the handle as required (about a swivel axis running vertically through the camera), tilt it (about a tilt axis running perpendicular thereto and perpendicular to the optical axis of the camera) and roll it (about a roll axis running through the arm of the cameraman) in order thus to create deliberate swivel, tilt and roll movements of the camera during filming.

With this known balance system with ball joint, the camera can be swivelled without restriction about the swivel axis several times in succession. The ball joint however only allows rotation about the tilt axis and roll axis within a restricted range. In particular rotation of the camera about the roll axis which runs through the cameraman's arm is possible only insofar as the mobility of the ball joint allows until it reaches its stop. From this twist angle onwards the cameraman must twist his arm to rotate the camera further about the roll axis, which makes the camera guidance unsteady; also the twist capacity of the cameraman's arm is naturally itself limited. Thus there is a greatly restricted range of rotation about the roll axis; in particular multiple rotations of the hand-held camera about this roll axis (known as barrel rolls) are not possible.

### DETAILS OF THE INVENTION

The object of the present invention is to create a balance system for hand-held cameras which allows greater freedom of movement for the camera.

This object is achieved by a balance system according to claim 1.

According to this a balance system for hand-held cameras has a balance arm and a handle, wherein the balance arm can be connected with a camera retaining mechanism and swivelled about a swivel axis in relation to the handle and tilted about a tilt axis running essentially perpendicular to the swivel axis. The balance arm can also be rotated in relation to the handle about a roll axis which also extends essentially perpendicular to the swivel axis. According to the invention the balance arm can be rotated without restriction about this roll axis in relation to the handle.

The balance arm and the camera attached thereto are consequently rotatable without restriction about the roll axis about the handle. The camera is thus completely decoupled from the cameraman's arm so that the twistability of the arm in no way restricts the range of rotation about the roll axis.

Rather, according to the invention it is even possible to rotate the camera about the roll axis several times in succession and, with simultaneous forward movement of the camera, to carry out the barrel rolls described above, which offers the cameraman using the hand-held camera totally new and effective possibilities for film design.

The balance system according to the invention is thus particularly suitable for DV and compact cameras in which comparatively few cables and electrical connections are used which could disrupt the roll movement.

Advantageous refinements of the balance system according to the invention arise from the sub-claims.

The balance arm can thus be connected with the handle via a multi-piece joint arrangement. For example three elements can be provided, where a first element firmly connected with the balance arm is mounted swivellably on a second element which in turn is mounted tiltably on a third element which again is mounted on the handle rotatably about the roll axis. In this design thus the first and second elements generate the swivel movement, the second and third elements the tilt movement and the third element and handle the roll movement of the camera in relation to the handle.

One advantage of this multi-piece arrangement is that the rotations about the various axes are decoupled from each other. This is not the case for example when using a ball joint which allows rotations about all three axes. In particular in the balance system according to the invention the roll axis can run through the centre of gravity of the entire system of balance arm, camera and any counterweights, where in contrast the roll axis in the known systems with ball joint always runs above this centre of gravity.

In the multi-piece joint arrangement at least two of the elements can be locked against each other. Thus for example it is possible to exclude rotation about the swivel axis and perform the tilting and/or rolling of the camera with a fixed swivel angle. Similarly for example the camera can be swivelled with a fixed tilt and/or roll angle. Thus there is a multiplicity of possible movement sequences of the camera in relation to the handle.

In an advantageous embodiment of the balance system according to the invention the balance arm is connected with the handle via a roller bearing arrangement for unrestricted rotation about the roll axis, where the handle forms the shaft of the roller bearing arrangement and the balance arm is connected with the hub of the roller bearing arrangement. In the case of the multi-piece joint arrangement, the handle can be mounted on the third element via a roller bearing arrangement rotatably about the roll axis, the third element forming the hub of this roller bearing arrangement and the handle the shaft of the roller bearing arrangement. In this way unrestricted and multiple rotation of the balance arm with the camera about the handle can be achieved in a simple manner.

The balance arm can for example be designed curved. Preferably it is folded up into a transport position.

In the curved design the balance arm extends from the camera in a curve to a point which essentially lies below the camera. At least one counterweight can be attached to this lower point or at another point on the balance arm in order to compensate for the weight of a camera attached to the balance arm. Instead of or in addition to the counterweight, a monitor or further accessory can be attached to the balance arm so that this gives a balanced complete system.

The camera can be attached to a camera retaining mechanism which in turn can be attached to the balance arm. Preferably the camera retaining mechanism consists of a base firmly connected with the balance arm and an attachment plate on which the camera can be mounted and which can be moved by means of setscrews in the right/left and/or in the forward/backward direction in relation to the base. In this way the centre of gravity of the camera can be moved in relation to the handle also connected with the balance arm, so that an axis running perpendicularly through the camera centre of gravity runs through the handle.

To guide the camera i.e. to generate the tilt, swivel and roll movements, a grip ring can be provided by means of which the balance arm and a camera attached thereto can be swivelled, tilted and rolled about the handle.

### BRIEF DESCRIPTION OF THE DRAWINGS

The invention is now described in more detail using the example of an embodiment shown in the drawings.

Individually these show:

FIG. 1 a balance system according to the invention with roll handle for hand-held cameras in perspective view,

FIG. 2 a side view of the balance system according to the invention,

FIG. 3 an enlarged perspective view of a handle and a joint arrangement of the balance system according to the invention,

FIG. 4 a cross section view of the handle and the joint arrangement,

FIG. 5 a longitudinal section through the handle and the joint arrangement, and

FIG. 6 a top view of a balance arm and the joint arrangement of the balance system according to the invention.

### DETAILED DESCRIPTION OF A PREFERRED EMBODIMENT

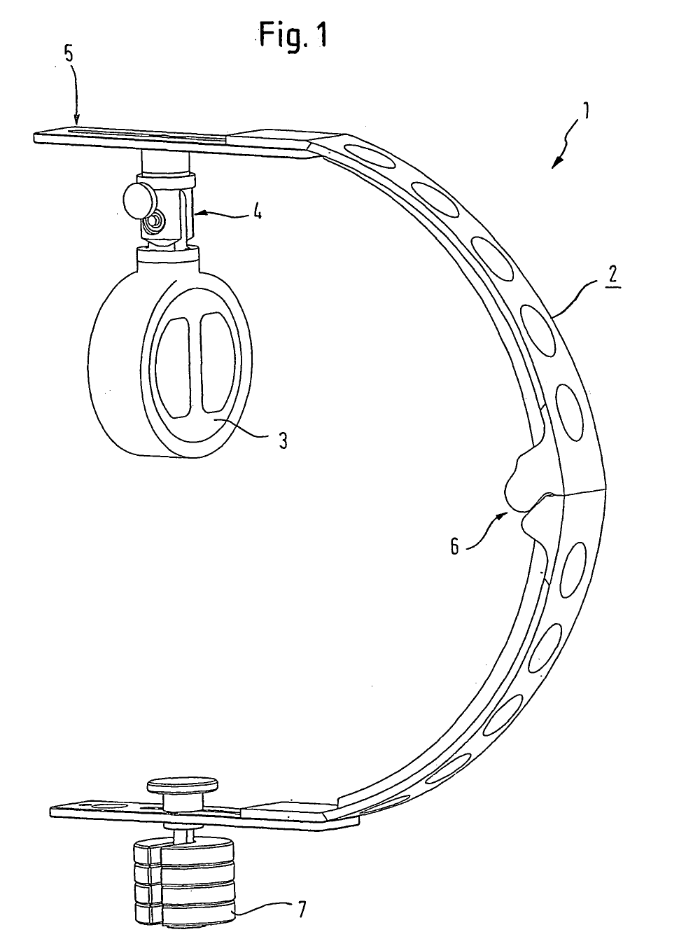

FIG. 1 shows a preferred embodiment of a balance system 1 according to the invention for hand-held cameras with a balance arm 2 and a handle 3 which are coupled together via a multi-piece joint arrangement 4.

At the upper end 5 of the balance arm 2 can be attached a camera retaining device (not shown) which in turn serves to hold a film or video camera or other device to be balanced.

In the example shown the balance arm is curved and designed foldable at a hinge point 6 so that it can be folded up for transport and thus takes up less space than in its extended state shown.

In order to balance the entire system, counterweights 7 are attached to the lower end of the balance arm 2. Instead of the counterweights 7, a monitor or similar can also be attached at this or at another point of the balance arm 2.

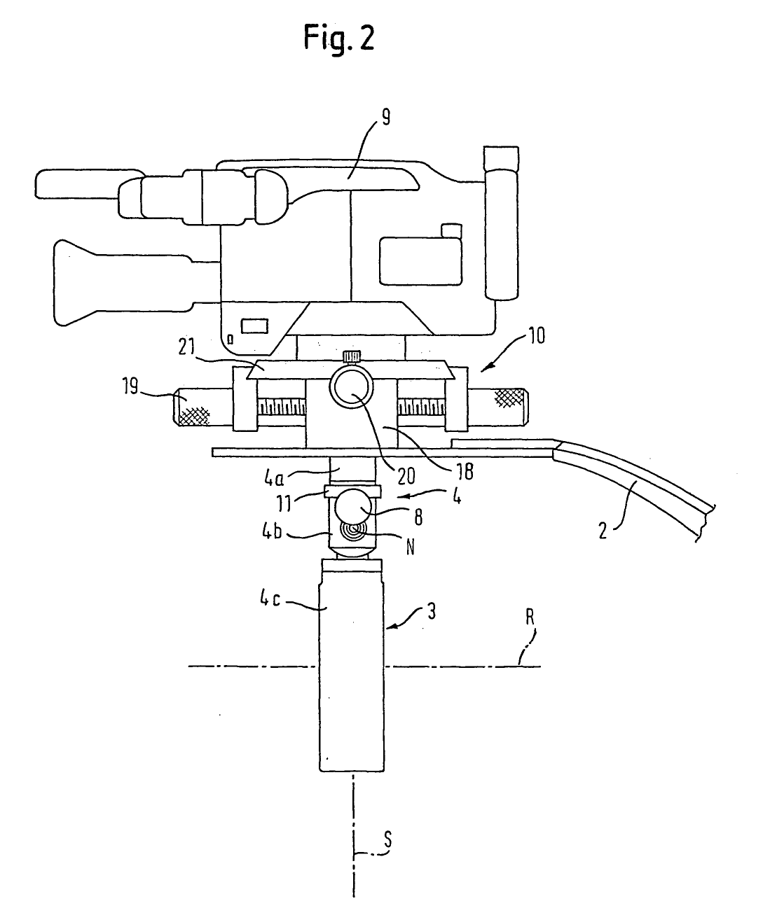

FIG. 2 shows the system according to the invention in side view. This view shows clearly the three axes which are essential for the movement of the system: the swivel axis S runs through the handle 3 vertically through a camera 9 attached to the balance arm 2 by means of a camera retaining device 10 and preferably through the centre of gravity of this camera 9. The balance arm 2 with the camera 9 attached thereto in this design can rotate without restriction about the swivel axis. The balance arm 2 can also be tilted in relation to the handle 3 about a tilt axis N, where this tilt can be performed in a range of ±90°. The arrangement of balance arm 2 and camera 9 can also be rotated beyond this without restriction and even repeatedly about a roll axis R. In the positions shown in which the balance arm 2 and the camera 9 are not tilted about tilt axis N, the roll axis R also runs perpendicular to swivel axis S. If the balance arm 2 is now tilted about the tilt axis N, the angle between the swivel axis S and the roll axis R changes; similarly the angle between the tilt axis N and the roll axis R changes on swivelling of the balance arm 2 about the swivel axis S. The swivel axis S thus always lies perpendicular to the tilt axis N.

The camera 9 is mounted on a camera retaining mechanism 10 which in turn is attached to the balance arm 2. The camera retaining mechanism 10 comprises a base 18, firmly connected with the balance arm, and an attachment plate 21 to which is attached the camera 9 and which can be moved by means of setscrews 19, 20 in the left/right and/or the forward/backward direction in relation to the base 18. In this way the centre of gravity of the camera 9 can be moved in relation to the handle 3, also connected with the balance arm 2, so that an axis running vertically through the centre of gravity of the camera 9 runs through the handle 3.

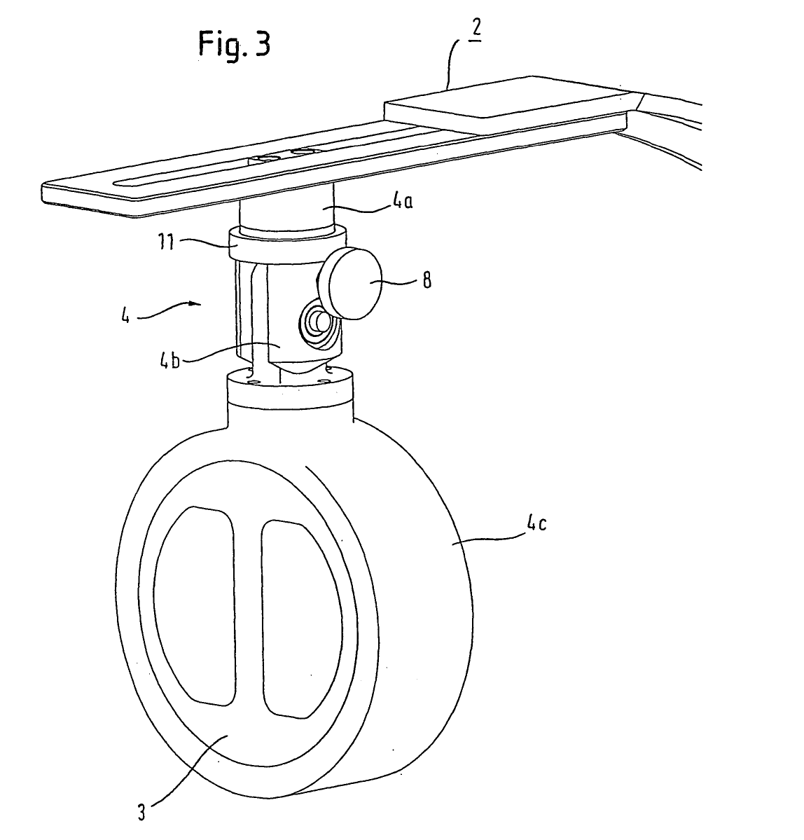

As is clear from FIGS. 2 and 3, in the embodiment shown as an example the joint arrangement 4 which connects the balance arm 2 with the handle 3 has three elements 4a, 4b and 4c. The first element 4a is connected with the balance arm 2 and can be rotated about the swivel axis S in relation to the second element 4b. The second element 4b in turn can be tilted about the tilt axis N in relation to the third element 4c which in this design assumes the function of the hub of a roller bearing arrangement. The shaft of this roller bearing arrangement corresponds to the handle 3 so that the balance arm 2 and the three elements 4a, 4b, 4c of the joint arrangement 4 can be rotated without restriction in relation to handle 3 several times in succession about the roll axis R.

In the embodiment shown the second element 4b can be locked on the third element 4c by means of a fixing screw 8, where in the locked position no further rotation can take place about the tilt axis N, but a predetermined tilt axis is set.

To guide the camera a grip ring 11 is provided. The grip ring 11 simultaneously acts as a clamping ring to guarantee a locking about the swivel axis. The first element 4a can consequently be fixed by means of the clamping ring 11 in relation to the second element 4b so that a tilt and/or roll movement of the camera can be performed with a fixed swivel angle.

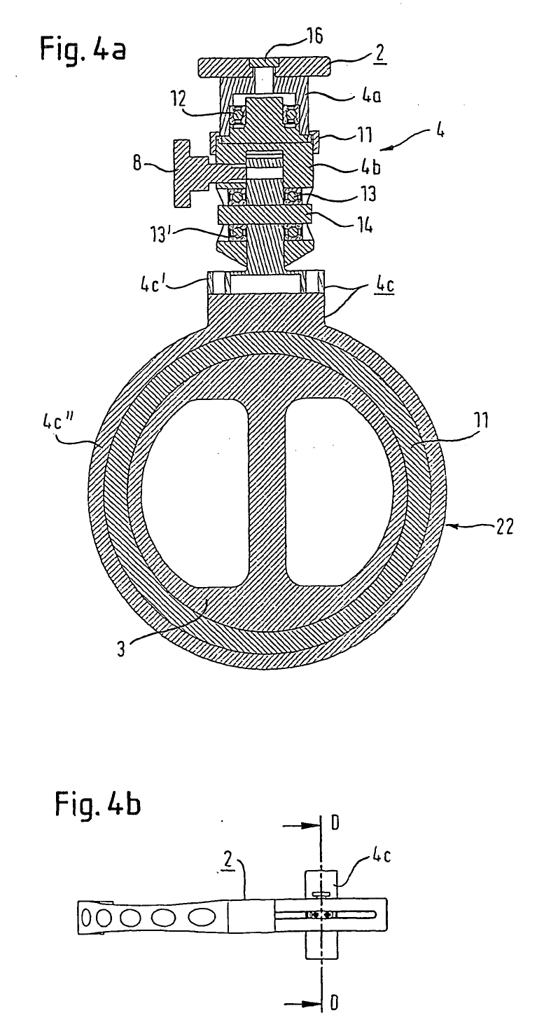

FIG. 4 shows the arrangement of the individual joint elements and their mounting in relation to each other, where FIG. 4a is a side view along line D-D of the top view in FIG. 4b. The. balance arm 2 and handle 3 are shown which are connected together via the joint arrangement 4. The first element 4a in the joint arrangement is mounted via a ball bearing 12 on the second element 4b, wherein the relative twist of the first element 4a and the second element 4b about the swivel axis can be prevented by means of the clamping ring 11. The second element 4b is in turn mounted on the third element 4c via two ball bearings 13, 13′ tiltably about tilt axis N, for which a connecting pin 14 is provided. To lock the second element 4b in relation to the third element 4c, the fixing bolt 8 is provided which can be screwed into a recess in the third element 4c and thus lock the two elements 4b, 4c against each other. The third element 4c is here designed in two pieces and comprises an upper cylindrical part 4c′ and a lower part 4c″ firmly connected thereto, which has the form of a circular ring. The lower part 4c″ at the same time corresponds to the hub of a roller bearing arrangement 22, the shaft of which forms the handle 3.

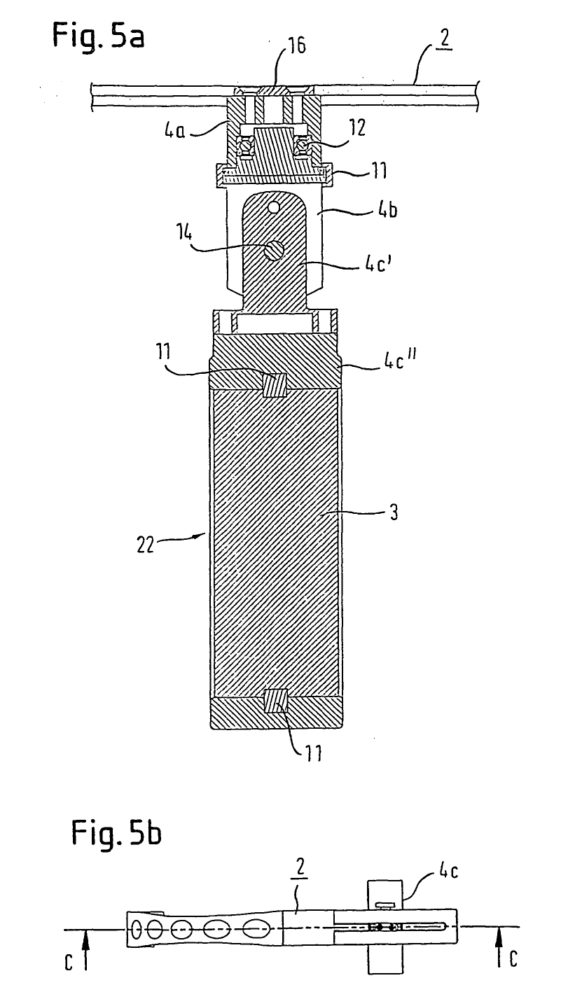

The roller bearing arrangement 22 of the circular ring 4c″, handle 3 and roller body 11 are even more clearly shown in FIG. 5, where FIG. 5a is a section along line C-C of the top view in FIG. 5b.

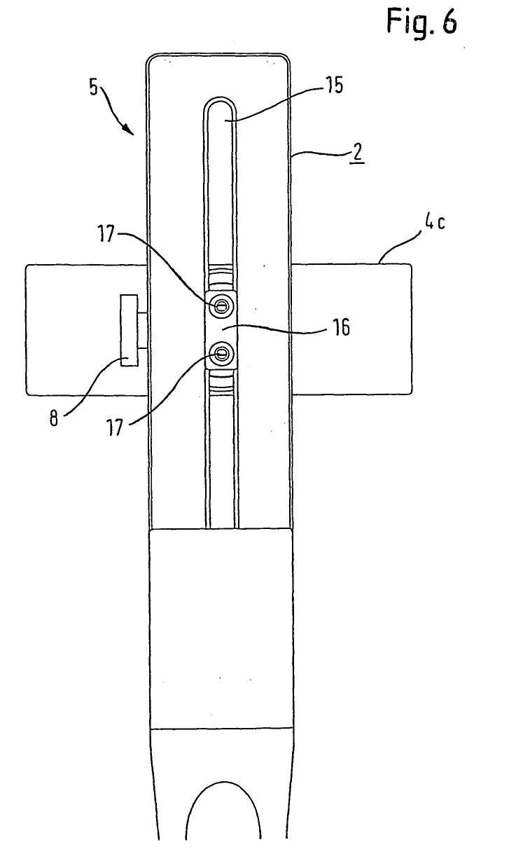

FIG. 6 finally again shows an enlarged top view onto a balance system according to the invention. Here it is clear that the upper part 5 of the balance arm 2 has a recess 15 in which is slideably arranged a connecting element 16 (see also FIG. 4a) which in turn is connected with the first element 4a of the joint arrangement 4. In this way the balance arm 2 can be moved in relation to the joint arrangement 4 and hence in relation to handle 3 along the recess 15. The connecting element 16 can then be fixed at the desired position by means of fixing bolts 17 in the recess 15.

1. Balanced system (1) for hand-held cameras (9) with a balance arm (2) and a handle (3),
the balance arm (2) being able to be connected with a camera retaining mechanism (10),
the balance arm (2) being able to be swivelled in relation to the handle (3) about a swivel axis (S) and tilted about a tilt axis (N) running essentially perpendicular to the swivel axis (S),
and the balance arm (2) also being able to be rotated in relation to the handle (3) about a roll axis (R) which, when the camera (9) is not tilted, also runs perpendicular to the swivel axis (S),
characterized in that in relation to the handle (3) the balance arm (2) can be rotated about the roll axis (R) without restriction, and the swivel axis (S) run through the handle (3).

2. Balance system (1) according to claim 1, characterized in that the balance arm (2) is connected with the handle (3) via a multi-piece joint arrangement (4).

3. Balance system (1) according to claim 2, characterized in that at least two elements of the multi-piece joint arrangement (4) can be locked in relation to each other.

4. Balance system (1) according to claim 2, characterized in that the multi-piece joint arrangement (4) has three elements (4a, 4b, 4c), a first element (4a) firmly connected with the balance arm (2) being mounted swivellably on a second element (4b) which in turn is mounted tiltably on a third element (4c) which again is mounted rotatably on the handle (3) about the roll axis (R).

5. Balance system (1) according to claim 4, characterized in that the handle (3) is mounted on the third element (4c) rotatably about the roll axis (R) via a roller bearing arrangement (22), the third element (4c) forming the hub of this roller bearing arrangement (22) and the handle (3) forming the shaft of this roller bearing arrangement (22).

6. Balance system (1) according to claim 1, characterized in that the balance arm (2) is connected with the handle (3) via a roller bearing arrangement (22) for unrestricted rotation about the roll axis (R), the handle (3) forming the shaft of the roller bearing arrangement (22) and the balance arm (2) being connected with the hub of the roller bearing arrangement (22).

7. Balance system (1) according to claim 1, characterized in that the balance arm (2) is designed to be curved.

8. Balance system (1) according to claim 1, characterized in that the balance arm (2) can be folded up (6) into a transport position.

9. Balance system (1) according to claim 1, characterized in that at least one counterweight (7) can be attached to the balance arm (2) in order to compensate for the weight of a camera (9) attached to the balance arm (2) via a camera retaining mechanism (10).

10. Balance system (1) according to claim 1, characterized in that the camera retaining mechanism (10) comprises a base (18), firmly connected with the balance arm, and an attachment plate (21) on which a camera (9) can be attached and which can be moved by setscrews (19, 20) in the right/left and/or the forward/backward direction in relation to the base (18).

11. Balance system (1) according to claim 1, characterized in that a grip ring (11) is provided by which the balance arm (2) and camera (9) attached thereto can be swivelled and tilted about the handle (3).

12. Balance system (1) according to claim 3, characterized in that the multi-piece joint arrangement (4) has three elements (4a, 4b, 4c), a first element (4a) firmly connected with the balance arm (2) being mounted swivellably on a second element (4b) which in turn is mounted tiltably on a third element (4c) which again is mounted rotatably on the handle (3) about the roll axis (R).

13. Balance system (1) according to claim 12, characterized in that the handle (3) is mounted on the third element (4c) rotatably about the roll axis (R) via a roller bearing arrangement (22), the third element (4c) forming the hub of this roller bearing arrangement (22) and the handle (3) forming the shaft of this roller bearing arrangement (22).

14. Balance system (1) according to claim 2, characterized in that the balance arm (2) is connected with the handle (3) via a roller bearing arrangement (22) for unrestricted rotation about the roll axis (R), the handle (3) forming the shaft of the roller bearing arrangement (22) and the balance arm (2) being connected with the hub of the roller bearing arrangement (22).

15. Balance system (1) according to claim 3, characterized in that the balance arm (2) is connected with the handle (3) via a roller bearing arrangement (22) for unrestricted rotation about the roll axis (R), the handle (3) forming the shaft of the roller bearing arrangement (22) and the balance arm (2) being connected with the hub of the roller bearing arrangement (22).

16. Balance system (1) according to claim 2, characterized in that the camera retaining mechanism (10) comprises a base (18), firmly connected with the balance arm, and an attachment plate (21) on which a camera (9) can be attached and which can be moved by setscrews (19, 20) in the right/left and/or the forward/backward direction in relation to the base (18).

17. Balance system (1) according to claim 3, characterized in that the camera retaining mechanism (10) comprises a base (18), firmly connected with the balance arm, and an attachment plate (21) on which a camera (9) can be attached and which can be moved by setscrews (19, 20) in the right/left and/or the forward/backward direction in relation to the base (18).

18. Balance system (1) according to claim 4, characterized in that the camera retaining mechanism (10) comprises a base (18), firmly connected with the balance arm, and an attachment plate (21) on which a camera (9) can be attached and which can be moved by setscrews (19, 20) in the right/left and/or the forward/backward direction in relation to the base (18).

19. Balance system (1) according to claim 12, characterized in that the camera retaining mechanism (10) comprises a base (18), firmly connected with the balance arm, and an attachment plate (21) on which a camera (9) can be attached and which can be moved by setscrews (19, 20) in the right/left and/or the forward/backward direction in relation to the base (18).

20. Balance system (1) according to claim 13, characterized in that the camera retaining mechanism (10) comprises a base (18), firmly connected with the balance arm, and an attachment plate (21) on which a camera (9) can be attached and which can be moved by setscrews (19, 20) in the right/left and/or the forward/backward direction in relation to the base (18).
